(19) United States
(12) Patent Application Publication
(10) Pub. No.: US 2015/0319559 A1
(43) Pub. Date: Nov. 5, 2015

(54) APPARATUS AND METHOD FOR SETTING UP COMMUNICATION LINK IN WIRELESS COMMUNICATION SYSTEM

(71) Applicant: SAMSUNG ELECTRONICS CO., LTD., Gyeonggi-do (KR)

(72) Inventors: Jong-Hyo LEE, Gyeonggi-do (KR); Ji-Hye LEE, Seoul (KR); Se-Hee HAN, Seoul (KR); Jae-Eun KANG, Suwon-si (KR); Chil-Youl YANG, Seoul (KR); Myong-Hwan LEE, Gyeonggi-do (KR); Chun-Ho LEE, Gyeonggi-do (KR); Tae-Young LEE, Seoul (KR)

(21) Appl. No.: 14/649,808

(22) PCT Filed: Dec. 4, 2013
(86) PCT No.: PCT/KR2013/011151

§ 371 Date: Jun. 4, 2015

(30) Foreign Application Priority Data
Dec. 4, 2012 (KR) 10-2012-0139925

(51) Int. Cl. H04W 4/00; H04W 40/24; H04L 29/06; H04L 29/12; H04W 72/04

(52) U.S. Cl. CPC H04W 4/008; H04L 61/103; H04W 72/0406; H04L 65/10; H04W 40/24; H04W 88/02

(57) ABSTRACT

An apparatus and a method for setting up a communication link in a wireless communication system are provided. The terminal exchanges at least one information of group formation information required to negotiate a role between the terminal and a counterpart terminal, Internet Protocol (IP) allocation information required for IP allocation and Address Resolution Protocol (ARP) information required for exchange of ARPs, with the counterpart terminal. The terminal sets up a main communication link between the terminal and the counterpart terminal based on the exchanged at least one information.

### PRIORITY

This application is a National Phase Entry of PCT International Application No. PCT/KR2013/011151, which was filed on Dec. 4, 2013, and claims priority to Korean Patent Application No. 10-2012-0139925, which was filed on Dec. 4, 2012, the content of each of which is incorporated herein by reference.

### BACKGROUND

1. Field of the Invention

The present invention relates generally to an apparatus and a method for setting up a communication link in a wireless communication system, and more particularly, to an apparatus and a method for setting up a communication link at a high speed in a wireless communication system.

2. Description of the Related Art

With the advent of smart phones and tablet Personal Computers (PCs), an environment has been created in which various pieces of information can be acquired and shared through wireless communication. According to needs of users who intend to more quickly receive services, research on providing services at a high speed is in progress.

Recently, in the most widely used Wireless Fidelity (Wi-Fi) communication, multiple procedures must be performed in order to set up a communication link between terminals. However, the multiple procedures cause a problem of increasing a time period required to set up a communication link.

Accordingly, in order to improve the degree of satisfaction of users of communication services, there is a need for a technology for setting up a communication link at a high speed.

### SUMMARY

The present invention has been made to address at least the above-mentioned problems and/or disadvantages and to provide at least the advantages described below.

Accordingly, an aspect of the present invention is to provide an apparatus and a method for setting up a communication link at a high speed in a wireless communication system.

Another aspect of the present invention is to provide an apparatus and a method in which terminals exchange required information prior to setting up a communication link between each other.

Another aspect of the present invention is to provide an apparatus and a method in which terminals exchange information required for a network service with each other after the terminals set up a communication link.

In accordance with an aspect of the present invention, a method for setting up a communication link by a terminal in a wireless communication system is provided. The method includes exchanging, by the terminal, at least one information of group formation information required to negotiate a role between the terminal and a counterpart terminal, Internet Protocol (IP) allocation information required for IP allocation and Address Resolution Protocol (ARP) information required for exchange of ARPs, with the counterpart terminal; and setting up a main communication link between the terminal and the counterpart terminal based on the exchanged at least one information.

In accordance with another aspect of the present invention, a terminal for setting up a communication link in a wireless communication system is provided. The terminal includes a controller that exchanges at least one information of group formation information required to negotiate a role between the terminal and a counterpart terminal, Internet Protocol (IP) allocation information required for IP allocation and Address Resolution Protocol (ARP) information required for exchange of ARPs, with the counterpart terminal; and a transmitter/receiver that sets up a main communication link between the terminal and the counterpart terminal based on the exchanged at least one information.

### BRIEF DESCRIPTION OF THE DRAWINGS

The above and other aspects, features, and advantages of the present invention will be more apparent from the following description, taken in conjunction with the accompanying drawings, in which:

FIG. 1 is a signal flow diagram illustrating two terminals setting up a communication link in a wireless communication system according to an embodiment of the present invention;

FIG. 2 is a block diagram of two terminals setting up a communication link in a wireless communication system according to an embodiment of the present invention;

FIG. 3 is a block diagram of two terminals setting up a communication link between the two terminals in a wireless communication system according to an embodiment of the present invention;

FIG. 4 is a block diagram in which a new terminal participates in a preset communication link in a wireless communication system according to an embodiment of the present invention;

FIG. 5 is a block diagram of two terminals setting up a communication link between the two terminals in a vehicle control system according to an embodiment of the present invention; and

FIG. 6 is a block diagram of two terminals setting up a communication link between the two terminals in a home network system according to an embodiment of the present invention.

### DETAILED DESCRIPTION OF EMBODIMENTS OF THE INVENTION

Hereinafter, the present invention is described in detail with reference to the accompanying drawings. In the following description of the present invention, a detailed description of known functions and configurations incorporated herein are omitted when it may make the subject matter of the present invention unclear. In addition, terms described below are defined in consideration of the functions of the present invention, but may vary according to the intention or convention of a user or an operator. Therefore, a definition will be made based on the overall contents of the present disclosure.

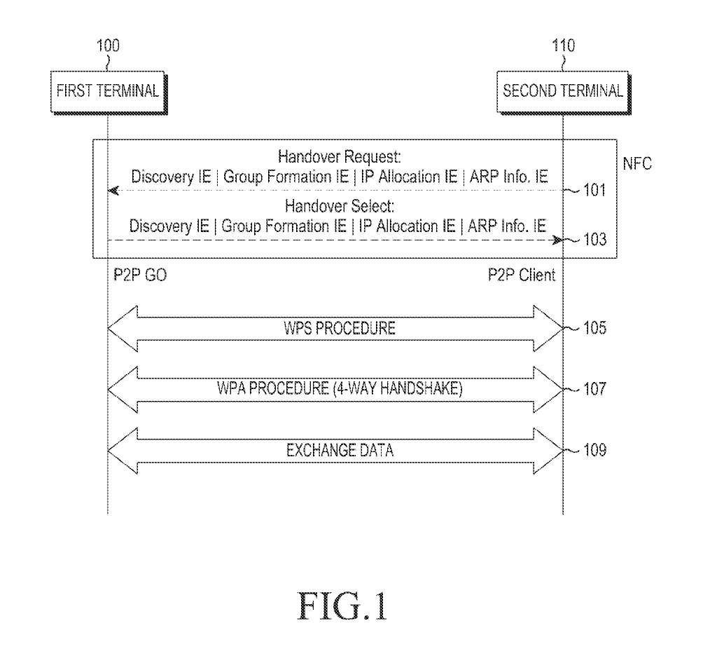

FIG. 1 is a signal flow diagram illustrating two terminals setting up a communication link in a wireless communication system according to an embodiment of the present invention.

Referring to FIG. 1, the wireless communication system includes a first terminal 100 and a second terminal 110. In an embodiment of the present invention, examples of a terminal may include all terminals capable of performing wireless communication.

The first terminal 100 transmits at least one of a discovery Information Element (IE), a group formation IE, an Internet Protocol (IP) allocation IE, and an Address Resolution Protocol (ARP) IE and receives at least one of a discovery Information Element (IE), a group formation IE, an Internet Protocol (IP) allocation IE, and an Address Resolution Protocol (ARP) IE to/from the second terminal 110 by using a Near Field Communication (NFC) technology. In this case, the discovery IE includes information that a terminal needs in order to discover a counterpart terminal, service information that the terminal itself can provide to the counterpart terminal, and the like. The group formation IE includes information required to negotiate a role (e.g., a group owner or a client) between the terminal and the counterpart terminal. The IP allocation IE includes information required for IP allocation. The ARP IE includes Media Access Control (MAC) address information required for the exchange of ARPs.

In an embodiment of the present invention, terminals exchange discovery IEs, group formation IEs, IP allocation IEs, and ARP IEs with each other by using NFC technology. However, the terminals may exchange the discovery IEs, the group formation IEs, the IP allocation IEs, and the ARP IEs with each other by using a Bluetooth Low Energy (BLE) technology.

Hereinafter, a detailed description is made of an operation in which the first terminal 100 and the second terminal 110 exchange discovery IEs, group formation IEs, IP allocation IEs, and ARP IEs with each other.

The second terminal 110 transmits an Out-Of-Band (OOB) message (e.g., a handover request message), which includes at least one of a discovery IE, a group formation IE, an IP allocation IE, and an ARP IE to the first terminal 100 in step 101. In this case, the discovery IE includes information required to discover the first terminal 100 and service information that the second terminal 110 can provide to the first terminal 100. The group formation IE includes information required to negotiate a role between the first terminal 100 and the second terminal 110. The IP allocation IE includes information required for IP allocation. The ARP IE includes MAC address information required for the exchange of ARPs.

The first terminal 100 transmits an OOB message (e.g., a handover select message), which includes at least one of a discovery IE, a group formation IE, an IP allocation IE, and an ARP IE to the second terminal 110 in step 103. In this case, the discovery IE includes information required to discover the second terminal 110 and service information that the first terminal 100 can provide to the second terminal 110. The group formation IE includes information required to negotiate a role between the first terminal 100 and the second terminal 110. The IP allocation IE includes information required for IP allocation. The ARP IE includes MAC address information required for the exchange of ARPs.

After the first terminal 100 and the second terminal 110 exchange the group formation IEs with each other in step 101 and step 103, each of the first terminal 100 and the second terminal 110 determines its own role in a Wi-Fi Peer-to-Peer (P2P) connection, corresponding to both the group formation IE that each of the first terminal 100 and the second terminal 110 has transmitted and the group formation IE that each of the first terminal 100 and the second terminal 110 has received from the counterpart terminal. In an embodiment of the present invention, the first terminal 100 serves as a Group Owner (GO) in the Wi-Fi P2P connection and the second terminal 110 serves as a client in the Wi-Fi P2P connection.

Specifically, the first terminal 100, which first executes a relevant application, determines clients belonging to a relevant group and forms a group through NFC tagging, while desiring to become a GO itself. Alternatively, in a situation where the relevant application is not executed, the first terminal 100 may be determined as a GO through only NFC tagging. In an embodiment of the present invention, related information required to form a group is transmitted to a client through an OOB message.

Then, each of the first terminal 100 and the second terminal 110 determines an IP address according to its own determined role, and generates an ARP table based on the determined IP address and the MAC address acquired by using the ARP IE. The ARP table represents a mapping relation between an IP address and a MAC address.

Then, the first terminal 100 and the second terminal 110 set up a Wi-Fi P2P connection corresponding to a main communication connection. Specifically, the first terminal 100 and the second terminal 110 perform a Wi-Fi Protected Setup (WPS) procedure in step 105 and a Wi-Fi Protected Access (WPA) procedure (e.g., an authentication procedure using 4-way handshake) in step 107, and thereby set up a Wi-Fi P2P connection. When the first terminal 100 and the second terminal 110 complete the setup of the Wi-Fi P2P connection, the first terminal 100 and the second terminal 110 exchange data with each other in step 109.

As described above, according to an embodiment of the present invention, the first terminal 100 and the second terminal 110 previously exchange the group formation IEs, which are required in the process for setting up the Wi-Fi P2P connection, with each other through the OOB messages, so that the terminals can set up the Wi-Fi P2P connection at a high speed. Also, according to an embodiment of the present invention, the terminals previously exchange the IP allocation IEs and the ARP IEs, which are required for a network service following the setup of the P2P connection, through the OOB messages, so that a time period required to provide the network service can be reduced.

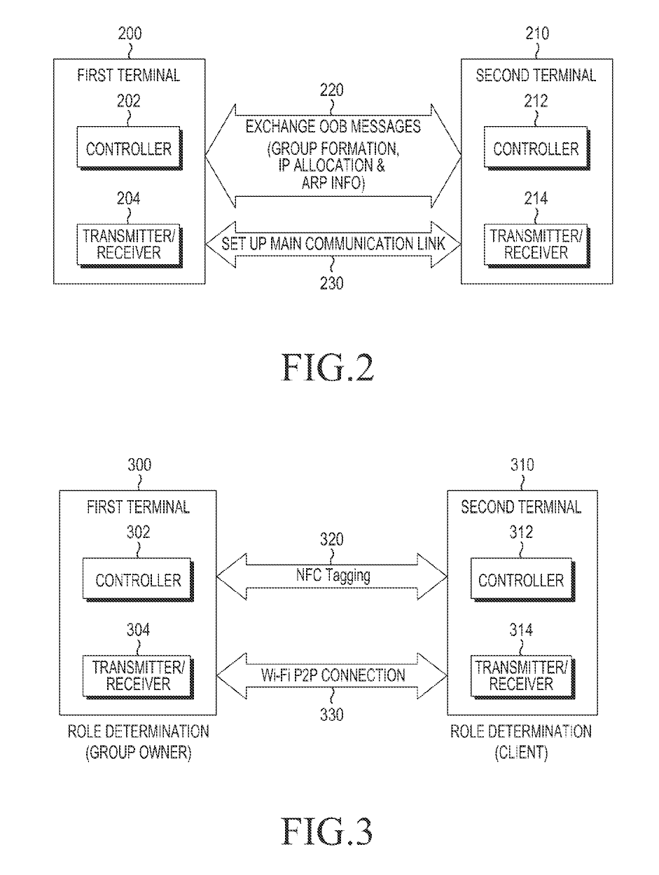

FIG. 2 is a block diagram of two terminals setting up a communication link in a wireless communication system according to an embodiment of the present invention.

Referring to FIG. 2, a first terminal 200 includes a controller 202 and a transmitter/receiver 204 (e.g. transceiver), and a second terminal 210 includes a controller 212 and a transmitter/receiver 214 (e.g. transceiver).

The controller 202 of the first terminal 200 and the controller 212 of the second terminal 210 exchange at least one information of group formation information, IP allocation information, and ARP information, through OOB messages in step 220. In step 220, the OOB messages may be exchanged by using NFC technology, BLE technology, or the like.

According to an embodiment of the present invention, the group formation information includes information required to negotiate a role (e.g., a GO or a client) between the first terminal 200 and the second terminal 210. The IP allocation information includes information required for IP allocation. The ARP information includes MAC address information required for the exchange of ARPs.

In other words, the controller 202 of the first terminal 200 determines whether the first terminal 200 is a GO terminal or a client terminal, corresponding to the group formation information that the controller 202 of the first terminal 200 has transmitted and the group formation information received from the controller 212 of the second terminal 210. Then, the controller 202 of the first terminal 200 determines its own IP address, corresponding to the IP allocation formation that the controller 202 of the first terminal 200 has transmitted and the IP allocation formation received from the controller 212 of the second terminal 210, according to the determined role.

Then, the controller 202 of the first terminal 200 generates an ARP table representing a mapping relation between the IP address and the MAC address, corresponding to the IP allocation information and the ARP information that the controller 202 of the first terminal 200 has transmitted and the IP allocation information and the ARP information that the controller 202 of the first terminal 200 has received from the controller 212 of the second terminal 210.

In an embodiment of the present invention, the controller 202 of the first terminal 200 determines its own role and its own IP address before generating the ARP table. The above-described operation can be similarly applied to the controller 212 of the second terminal 200.

The controller 202 of the first terminal 200 additionally exchanges discovery information with the controller 212 of the second terminal 210 through OOB messages. According to an embodiment of the present invention, the discovery information includes both information that a terminal needs in order to discover a counterpart terminal and service information that the terminal can provide to the counterpart terminal.

In step 230, the transmitter/receiver 204 of the first terminal 200 sets up a main communication link between itself and the transmitter/receiver 214 of the second terminal 210. Examples of the main communication link include a Wi-Fi P2P connection, a Bluetooth connection, and the like.

The transmitter/receiver 204 of the first terminal 200 transmits and receives network service data to/from the transmitter/receiver 214 of the second terminal 210, corresponding to the ARP table that the controller 202 of the first terminal 200 has generated and the IP address that the controller 202 of the first terminal 200 has determined.

Hereinafter, examples will be described in which an embodiment of the present invention is applied to different environments.

In an embodiment of the present invention, multiple terminals share content.

In an embodiment of the present invention, an environment is described in which two or more terminals temporarily share content (e.g., photographs, music, moving images, an address book, etc.) or share materials for a meeting during the meeting.

FIG. 3 is a block diagram of two terminals setting up a communication link between the two terminals in a wireless communication system according to an embodiment of the present invention.

Referring to FIG. 3, a first terminal 300 and a second terminal 310 exchange at least one information of discovery information, group formation information, IP allocation information, and ARP information with each other through NFC tagging in step 320. In step 320, the at least one information of the discovery information, the group formation information, the IP allocation information, and the ARP information is exchanged through OOB messages, and NFC tagging is performed by the controller 302 of the first terminal 300 and the controller 312 of the second terminal 310. In an embodiment of the present invention, NFC tagging is described as an example, but the at least one information of the discovery information, the group formation information, the IP allocation information, and the ARP information may be exchanged through BLE communication.

Each of the controller 302 of the first terminal 300 and the controller 312 of the second terminal 310 determines its own role by using the group formation information exchanged in step 320. In an embodiment of the present invention, the first terminal 300 is determined as a GO and the second terminal 310 is determined as a client.

Then, the controller 302 of the first terminal 300 determines an IP address according to its own previously-determined role corresponding to the IP allocation information exchanged in step 320 and generates an ARP table representing a mapping relation between the IP address and the MAC address corresponding to the IP allocation information and the ARP information which have been exchanged in step 320.

In step 330, the first terminal 300 and the second terminal 310 set up a main communication link (i.e., a Wi-Fi P2P connection) at a high speed corresponding to their own roles. The transmitter/receiver 304 (e.g. transceiver) of the first terminal 300 transmits and receives network service data to/from the transmitter/receiver 314 (transceiver) of the second terminal 310 corresponding to both the ARP table that the controller 302 of the first terminal 300 has generated and the IP address that the controller 302 of the first terminal 300 has determined.

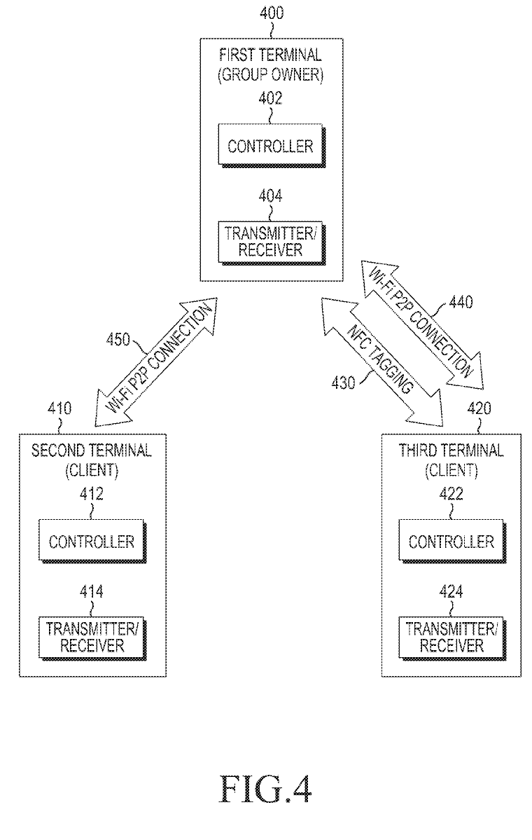

FIG. 4 is a block diagram in which a new terminal participates in a preset communication link in the wireless communication system according to the first embodiment of the present invention.

Referring to FIG. 4, a first terminal 400 is in a state of setting up a P2P connection between the first terminal 400 and a second terminal 410, in step 450. In an embodiment of the present invention, the first terminal 400 is a GO terminal and the second terminal 410 is a client terminal.

Also, a third terminal 420 which is a new terminal forms an NFC link through NFC tagging between the third terminal 420 and the first terminal 400, which is a GO, or the second terminal 410 which is a client, and exchanges at least one information of group formation information, IP allocation information, and ARP information with the first terminal 400 or the second terminal 410. In an embodiment of the present invention, the third terminal 420 forms an NFC link through NFC tagging between the third terminal 420 and the first terminal 400, which is the GO terminal, and exchanges at least one information of group formation information, IP allocation information, and ARP information with the first terminal 400.

The third terminal 420 forms an NFC link through NFC tagging between the third terminal 420 and the first terminal 400 and exchanges at least one information of discovery information, group formation information, IP allocation information, and ARP information with the first terminal 400 in step 430. In step 430, the at least one information of the discovery information, the group formation information, the IP allocation information, and the ARP information is exchanged through OOB messages, and NFC tagging is performed by the controller 402 of the first terminal 400 and the controller 422 of the third terminal 420. In an embodiment of the present invention, the group formation information that the third terminal 420 transmits includes information indicating that a group including the first terminal 400 and the second terminal 410 has currently been formed. Also, NFC tagging is described as an example, but the at least one information of the discovery information, the group formation information, the IP allocation information, and the ARP information may be exchanged through BLE communication.

After the controller 422 of the third terminal 420 receives, from the first terminal 400, the group formation information including the information indicating the formation of the group, the controller 422 of the third terminal 420 determines its own role as a client. Then, the controller 422 of the third terminal 420 determines an IP address according to its own previously-determined role corresponding to the IP allocation information exchanged in step 430 and generates an ARP table representing a mapping relation between the IP address and the MAC address corresponding to the IP allocation information and the ARP information which have been exchanged in step 430.

Then, the first terminal 400 and the third terminal 420 set up a main communication link (e.g., a Wi-Fi P2P connection) at a high speed corresponding to their own roles, in step 440. A transmitter/receiver 404 (e.g. transceiver) of the first terminal 400 transmits and receives network service data to/from a transmitter/receiver 424 (e.g. transceiver) of the third terminal 420, corresponding to both the ARP table that the controller 402 of the first terminal 400 has generated and the IP address that the controller 402 of the first terminal 400 has determined.

In an embodiment of the present invention, a terminal shares content with a car head unit.

In an embodiment of the present invention, a portable terminal shares content or exchanges vehicle control information with a terminal (e.g., a car head unit) which is installed in a vehicle and controls all functions provided by the vehicle.

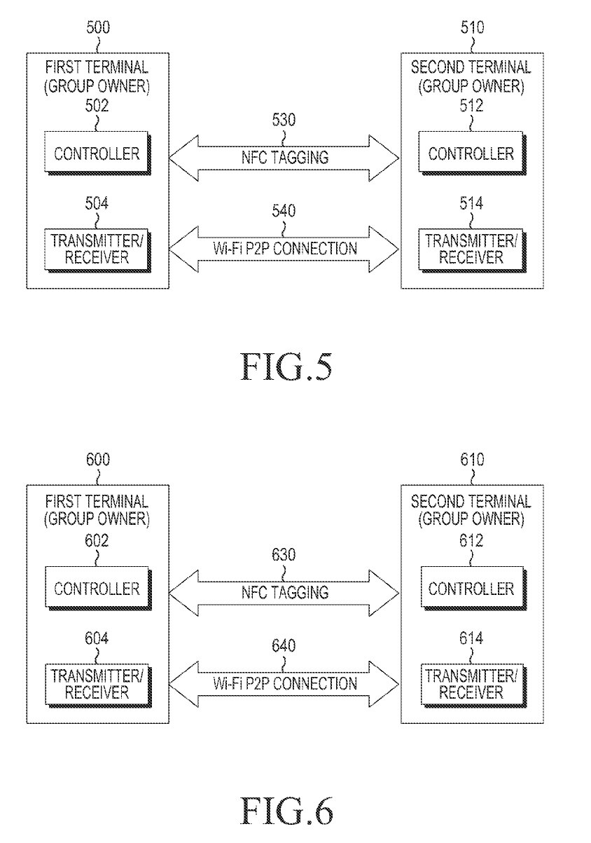

FIG. 5 is a block diagram of two terminals setting up a communication link between the two terminals in a vehicle control system according to an embodiment of the present invention.

Referring to FIG. 5, in an embodiment of the present invention, the first terminal 500 is the portable terminal and the second terminal 510 is the terminal which is installed in a vehicle and controls all functions provided by the vehicle.

The first terminal 500 and the second terminal 510 exchange at least one information of discovery information, group formation information, IP allocation information, and ARP information with each other through NFC tagging in step 530. In step 530, the at least one information of the discovery information, the group formation information, the IP allocation information, and the ARP information is exchanged through OOB messages, and NFC tagging is performed by the controller 502 of the first terminal 500 and the controller 512 of the second terminal 510. In an embodiment of the present invention, NFC tagging is described as an example, but the at least one information of the discovery information, the group formation information, the IP allocation information and the ARP information may be exchanged through BLE communication.

Each of the controller 502 of the first terminal 500 and the controller 512 of the second terminal 510 determines its own role by using the group formation information exchanged in step 530. In an embodiment of the present invention, the first terminal 500 and the second terminal 510 both serve as GOs.

Then, the controller 502 of the first terminal 500 determines an IP address according to its own previously-determined role corresponding to the IP allocation information exchanged in step 530 and generates an ARP table representing a mapping relation between the IP address and the MAC address corresponding to the IP allocation information and the ARP information which have been exchanged in step 530.

Then, the first terminal 500 and the second terminal 510 set up a main communication link (i.e., a Wi-Fi P2P connection) at a high speed corresponding to their own roles in step 540. The transmitter/receiver 504 (e.g. transceiver) of the first terminal 500 transmits and receives network service data to/from the transmitter/receiver 514 (e.g. transceiver) of the second terminal 510 corresponding to both the ARP table that the controller 502 of the first terminal 500 has generated and the IP address that the controller 502 of the first terminal 500 has determined.

In an embodiment of the present invention, a terminal shares content with a home appliance.

In an embodiment of the present invention, a portable terminal shares content or exchanges home appliance control information with a home appliance.

FIG. 6 is a block diagram of two terminals setting up a communication link between the two terminals in a home network system according to an embodiment of the present invention.

Referring to FIG. 6, in an embodiment of the present invention, a first terminal 600 is a portable terminal and a second terminal 610 is a home appliance or any terminal which can be installed in a house.

The first terminal 600 and the second terminal 610 exchange at least one information of discovery information, group formation information, IP allocation information and ARP information with each other through NFC tagging in step 630. In step 630, the at least one information of the discovery information, the group formation information, the IP allocation information, and the ARP information is exchanged through OOB messages, and the NFC tagging is performed by the controller 602 of the first terminal 600 and the controller 612 of the second terminal 610. In an embodiment of the present invention, NFC tagging is described as an example, but the at least one information of the discovery information, the group formation information, the IP allocation information and the ARP information may be exchanged through BLE communication.

Each of the controller 602 of the first terminal 600 and the controller 612 of the second terminal 610 determines its own role by using the group formation information exchanged in step 630. In an embodiment of the present invention, it is determined that the first terminal 600 and the second terminal 610 both serve as GOs.

Then, the controller 602 of the first terminal 600 determines an IP address according to its own previously-determined role corresponding to the IP allocation information exchanged in step 630 and generates an ARP table representing a mapping relation between the IP address and the MAC address corresponding to the IP allocation information and the ARP information which have been exchanged in step 630.

Then, the first terminal 600 and the second terminal 610 set up a main communication link (i.e., a Wi-Fi P2P connection) at a high speed corresponding to their own roles in step 640. The transmitter/receiver 604 (e.g. transceiver) of the first terminal 600 transmits and receives network service data to/from the transmitter/receiver 614 (e.g. transceiver) of the second terminal 610 corresponding to both the ARP table that the controller 602 of the first terminal 600 has generated and the IP address that the controller 602 of the first terminal 600 has determined.

It can be appreciated that the method and the apparatus for setting up a communication link according to embodiments of the present invention may be implemented in hardware, software, or a combination of hardware and software. Any such software may be stored, for example, in a volatile or non-volatile storage device such as a Read Only Memory (ROM), a memory such as a Random Access Memory (RAM), a memory Integrated Circuit (IC), a memory device, or a recordable optical or magnetic medium such as a Compact Disc (CD), a Digital Video Disc (DVD), a magnetic disk, or a magnetic tape, regardless of its ability to be erased or its ability to be re-recorded. It can be also appreciated that a memory included in a mobile terminal is one example of non-transitory machine-readable devices suitable for storing a program including instructions that are executed by a processor to thereby implement embodiments of the present invention.

Accordingly, the present invention includes a program for code implementing the apparatus and method described in the appended claims of the present disclosure and a non-transitory machine (a computer or the like)-readable storage medium for storing the program. Moreover, such a program as described above can be electronically transferred through an arbitrary medium such as a communication signal transferred through cable or wireless connection, and the present invention properly includes equivalents thereof.

The method and the apparatus for setting up a communication link according to embodiments of the present invention may receive a program from a device for providing a program, which is connected to a terminal by wire or wirelessly, and may store the received program. The program supply apparatus may include a program that includes instructions to execute the embodiments of the present invention, a memory that stores information or the like required for the embodiments of the present invention, a communication unit that conducts wired or wireless communication with the electronic apparatus, and a control unit that transmits a corresponding program to a transmission/reception apparatus in response to the request from the electronic apparatus or automatically.

Although certain embodiments of the present invention have been described in the detailed description of the present invention, various modifications may be made without departing from the scope and spirit of the present invention. Therefore, the scope of the present invention should not be defined as being limited to the embodiments of the present invention, but should be defined by the appended claims and the equivalents thereof.

1. A method of setting up a communication link by a terminal in a wireless communication system, the method comprising:
exchanging, by the terminal, at least one information of group formation information related to negotiating a role between the terminal and a counterpart terminal, internet protocol (IP) allocation information related to for IP allocation, and address resolution protocol (ARP) information related to exchange of ARPs, with the counterpart terminal; and
setting up a main communication link between the terminal and the counterpart terminal based on the exchanged at least one information.

2. The method as claimed in claim 1, further comprising determining, based on the group formation information, whether the terminal is a group owner terminal or a client terminal, if the at least one information exchanged with the counterpart terminal comprises the group formation information.

3. The method as claimed in claim 2, further comprising determining an IP address of the terminal based on the IP allocation information and a result of the determination based on the group formation information of whether the terminal is the group owner terminal or the client terminal, if the at least one information exchanged with the counterpart terminal comprises the IP allocation information.

4. The method as claimed in claim 1, further comprising generating an ARP table representing a mapping relation between an IP address and a media access control (MAC) address, based on the IP allocation information and the ARP information, if the at least one information exchanged with the counterpart terminal comprises the IP allocation information and the ARP information.

5. The method as claimed in claim 4, further comprising transmitting and receiving, by the terminal, network service data to and from the counterpart terminal based on the IP address of the terminal and the ARP table.

6. The method as claimed in claim 1, further comprising exchanging at least one information of group formation information related to negotiating a role between a new terminal and one of the terminal and the counterpart terminal, the IP allocation information, and the ARP information, with the new terminal.

7. The method as claimed in claim 6, wherein the group formation information related to negotiating the role between the new terminal and one of the terminal and the counterpart terminal includes information indicating that a group including the terminal and the counterpart terminal has been formed.

8. The method as claimed in claim 1, wherein the group formation information, the IP allocation information, and the ARP information are exchanged through out-of-band (OOB) messages.

9. A terminal for setting up a communication link in a wireless communication system, the terminal comprising:
a controller configured to exchange at least one information of group formation information related to negotiating a role between the terminal and a counterpart terminal, internet protocol (IP) allocation information related to IP allocation, and address resolution protocol (ARP) information related to exchange of ARPs, with the counterpart terminal; and
a transceiver configured to set up a main communication link between the terminal and the counterpart terminal based on the exchanged at least one information.

10. The terminal as claimed in claim 9, wherein the controller is further configured to determine, based on the group formation information, whether the terminal is a group owner terminal or a client terminal, if the at least one information exchanged with the counterpart terminal comprises the group formation information.

11. The terminal as claimed in claim 10, wherein the controller is further configured to determine an IP address of the terminal based on the IP allocation information and a result of the determination based on the group formation information of whether the terminal is the group owner terminal or the client terminal, if the at least one information exchanged with the counterpart terminal comprises the IP allocation information.

12. The terminal as claimed in claim 9, wherein the controller is further configured to generate an ARP table representing a mapping relation between the IP address and a media access control (MAC) address, based on the IP allocation information and the ARP information, if the at least one information exchanged with the counterpart terminal comprises the IP allocation information and the ARP information.

13. The terminal as claimed in claim 12, wherein the transceiver is configured to transmit and receive network service data to and from the counterpart terminal based on the IP address of the terminal and the ARP table.

14. The terminal as claimed in claim 9, wherein the controller is further configured to exchange at least one information of group formation information related to negotiating a role between a new terminal and one of the terminal and the counterpart terminal, the IP allocation information, and the ARP information with the new terminal.

15. The terminal as claimed in claim 14, wherein the group formation information related to negotiating the role between the new terminal and one of the terminal and the counterpart terminal includes information indicating that a group including the terminal and the counterpart terminal has been formed.

16. The terminal as claimed in claim 9, wherein the at least one information of the group formation information, the IP allocation information, and the ARP information is exchanged through out-of-band (OOB) messages.

17. The method as claimed in claim 1, wherein exchanging, by the terminal, at least one information of the group formation information related to negotiating the role between the terminal and the counterpart terminal, the IP allocation information related to the IP allocation, and the ARP information related to exchange of the ARPs with the counterpart terminal is comprised of exchanging, by the terminal, at least one information of the group formation information related to negotiating the role between the terminal and the counterpart terminal, the IP allocation information related to the IP allocation, and the ARP information related to exchange of the ARPs with the counterpart terminal via one of near field tagging or Bluetooth Low Energy.

18. The method as claimed in claim 1, wherein setting up the main communication link between the terminal and the counterpart terminal based on the exchanged at least one information is comprised of setting up the main communication link between the terminal and the counterpart terminal based on the exchanged at least one information via one of a wireless fidelity peer-to-peer (Wi-Fi P2P) connection or a Bluetooth connection.

19. The terminal as claimed in claim 9, wherein the controller is further configured to exchange at least one information of the group formation information related to negotiating a role between the terminal and the counterpart terminal, the IP allocation information related to the IP allocation, and the ARP information related to exchange of the ARPs with the counterpart terminal via one of near field tagging or Bluetooth Low Energy.

20. The terminal as claimed in claim 9, wherein the transceiver is further configured to set up the main communication link between the terminal and the counterpart terminal based on the exchanged at least one information via one of a wireless fidelity peer-to-peer (Wi-Fi P2P) connection or a Bluetooth connection.
